(19) United States
(12) Patent Application Publication
(10) Pub. No.: US 2007/0209015 A1
(43) Pub. Date: Sep. 6, 2007

(54) Value selection for electronic document

(76) Inventor: Gerd M. Ritter, Heidelberg (DE)

Correspondence Address: FISH & RICHARDSON, P.C., PO BOX 1022, MINNEAPOLIS, MN, 55440-1022, US

(21) Appl. No.: 11/365,722

(22) Filed: Mar. 1, 2006

(51) Int. Cl. G06F 9/00; G06F 3/00

(52) U.S. Cl. 715/780; 715/810; 715/835; 715/968

(57) ABSTRACT

A method includes receiving in a computer system an input string that a user enters under guidance of a GUI configured for user entry of information for an electronic document that is to be created. The method includes searching, using the received input string, a repository for any value that is to be automatically associated with an input field in the GUI for inclusion in the electronic document. Upon the search identifying a number of values that exceeds a maximum number of values that the input field is configured to accept, the method includes: 1) associating with the input field at least one value selected from the identified values up to the maximum number of values; and 2) presenting a visual indicator to the user that the associated at least one value was selected from the identified values. The identified values, or at least the remainder thereof, can be buffered.

### TECHNICAL FIELD

The description relates to selecting one or more values for an electronic document.

### BACKGROUND

Many computer systems allow users to create, store and use electronic documents, such as business transaction documents. Examples of such documents include a sales order, service order or a quotation. The system often has an application program that when executed manages and uses these documents. Some of these programs provide a specific graphical user interface (GUI) for the user to enter the information to be included in a document to be created. For example, the GUI may present a form that includes a number of input fields on a computer display device. A user that wants to create an electronic document can then enter the relevant information in the respective fields. When done, the user can trigger the system to generate the document whereby the information associated with the respective fields becomes part of the created document.

Some existing systems provide a form of assistance to users in entering information for the document to be created. Particularly, when the user is working on a sales order document, the business application responsible for the document determines or finds, depending on the context and the user entries, values for fields of the sales order. Examples include: that the system can determine related entities or partners (e.g. employee responsible, the payer, or the goods recipient); the system can determine an organizational unit (e.g. the sales office); the system can find texts belonging to the sales order; the system can determine check if an ID is erroneous; the system can determine a location (e.g. a ship-to, or a ship from address); the system can perform a goods determination; or that the system can enter a search string into a field of the sales order and determination of the corresponding hits.

With regard to the “employee responsible” field, a sales representative may enter the buyer “Silverstone” in a sales order, and the business application in the backend then determines, depending on the country and region of this customer, the back-office employees that are responsible for this region. Four employees are found, but the sales order is configured to accept a maximum of one employee in this field. This is resolved in some existing systems by launching a popup window for selection of one of the employees. The sales representative sees the popup with the four employees after having entered the buyer. Then the sales representative can select one of the entries and the selected employee is stored as employee responsible within the document. Typically one of the employees is flagged as default; i.e., if the sales rep just hits the “enter” key on the popup, then this default is the value entered for the input field. That is, the system does not automatically choose any of the possible entries for the field, but rather presents them for the user to make the choice. This technique is used in the mySAP system available from SAP AG in Walldorf (Baden), Germany.

This procedure may, however, have some drawbacks. The one or several popup windows can be interruptive to the user, because the user must select one of the entries or at a minimum confirm the default selection. In some instances, the user cannot continue filling in information until all popup windows have been finished. This is particularly tedious and frustrating in what may be considered the 95% case, where the user chooses the default entry in each popup. Users choose the default entries for different reasons, which may include that the default entries typically are a sensible choice among the given alternatives, or that the user does not have sufficient information to make a meaningful choice between the alternatives. By contrast, in what may be considered the 5% case the user selects an entry other than the default one. This may be because the default entry was poorly chosen by the system, or because the user knows that the current situation is different from the typical and therefore requires a different choice.

### SUMMARY

The invention relates to aiding a user in entering information for creating an electronic document.

In a first general aspect, a method to be performed upon a user entering information for creating an electronic document includes receiving in a computer system an input string that a user enters under guidance of a graphical user interface (GUI). The GUI is configured for user entry of information for an electronic document that is to be created. The method includes searching, using the received input string, a repository for any value that is to be automatically associated with an input field in the GUI for inclusion in the electronic document. Upon the search identifying a number of values that exceeds a maximum number of values that the input field is configured to accept, the method includes: 1) associating with the input field at least one value selected from the identified values up to the maximum number of values; and 2) presenting a visual indicator to the user that the associated at least one value was selected from the identified values.

Implementations may include any or all of the following features. The user may enter the input string to make an entry for the input field and associating the at least one value with the input field may include replacing the input string with the at least one value. The user may enter the input string to make an entry for another input field in the GUI than the input field. The at least one value may be selected from the identified values based on a priority setting. The at least one value may be selected from the identified values using data from another input field in the GUI. The at least one value may be randomly selected from the identified values. The GUI may further include a message log that the user can access, and presenting the visual indicator may include adding a message to the message log. The visual indicator may include a user-selectable input control that the user can activate to have the computer system present at least the remainder of the identified values. The computer system may include a help function that the user can activate in relation to the input field to have the system present at least one candidate value that the input field is configured to accept. Presenting the visual indicator may include presenting at least a remainder of the identified values in the GUI upon the user activating the help function. Presenting the visual indicator may include automatically modifying a search function that is included in the help function. The at least one value may not be displayed in the GUI upon being associated with the input field. The at least one value may be displayed in the GUI upon being associated with the input field, and presenting the visual indicator may include highlighting the at least one value in the GUI. The method may further include storing at least a remainder of the identified values for user viewing. The storing may include buffering at least the remainder of the identified values in an application layer of the computer system.

In a second general aspect, a method to be performed upon a user entering information for creating an electronic document includes receiving, in a computer system, an input string that a user enters under guidance of an input field in a graphical user interface (GUI). The GUI is configured for user entry of information for an electronic document that is to be created. The method further includes searching, using the received input string, a repository for any value that is to be automatically associated with another input field in the GUI for inclusion in the electronic document. Upon the search identifying a number of values that exceeds a maximum number of values that the input field is configured to accept, the method further includes: 1) associating with the other input field at least one value selected from the identified values up to the maximum number of values; 2) buffering information including at least a remainder of the identified values; and 3) presenting a visual indicator to the user that the associated at least one value was selected from the identified values, wherein the user can access the buffered information using the visual indicator.

Implementations may include any or all of the following features. The at least one value and the remainder of the identified values may be buffered. The computer system may include a help function that the user can activate in relation to the other input field to have the system present at least one candidate value that the other input field is configured to accept, and the visual indicator may be presented in association with the help function. The help function may provide that the user can also search for candidate values that are not included in the buffered information.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a block diagram schematically showing a value being automatically placed in an input field upon a user making an entry in another input field.

FIG. 2 is a block diagram schematically showing a value being automatically placed in an input field upon a user making an entry in the input field.

FIG. 3 illustrates an example of how a GUI visually indicates that one or more automatically entered values was selected from a larger set and lets the user select a value that is different than the one currently entered.

FIGS. 4a-b illustrate examples of incorporating value help to aid the user in making a value entry in the field or to change the value displayed in a field.

FIG. 5 is a flow chart illustrating an exemplary process flow.

FIG. 6 is a block diagram of a general computer system.

Like reference numerals in the various drawings indicate like elements.

### DETAILED DESCRIPTION

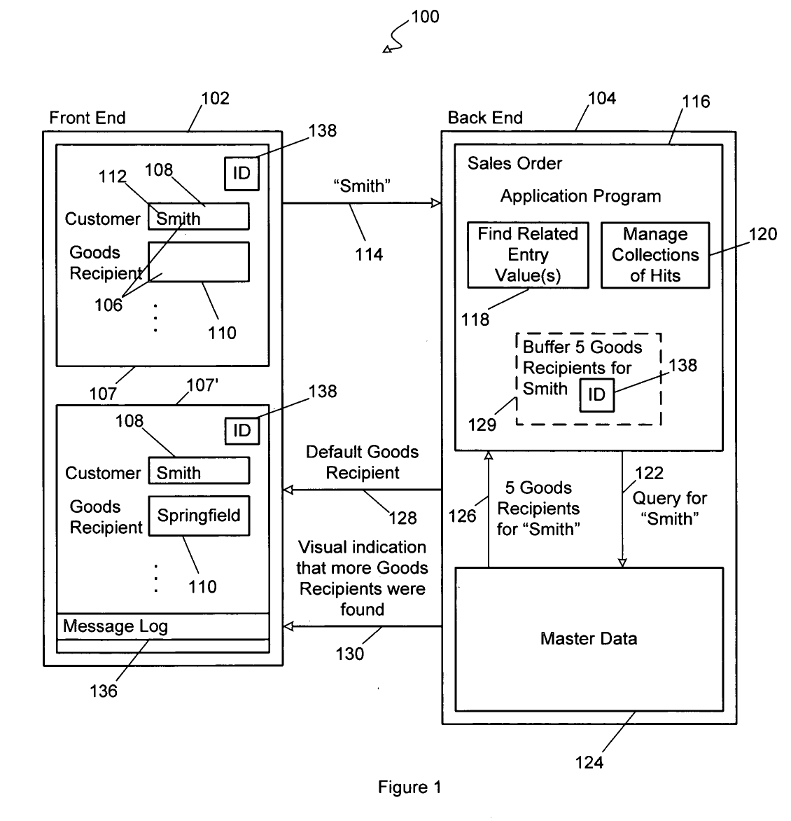

FIG. 1 illustrates a system 100 including a front end 102 and a back end 104. A user may use the system 100 for creating electronic documents. The system is configured to populate one or more fields 106 in the front end 100 using results of a search that is based on user-entered information. Particularly, the system visually indicates to the user if the system selected the automatically entered value(s) was selected from a larger set of values.

In this example, a user is operating the system 100 to enter information that is to be included in a sales order that is to be created. For this purpose, a graphical user interface (GUI) 107 is generated in the front end. The GUI 107 has interactive fields that are used to enter information about the sales order, such as a customer field 108 for the name of the customer or a goods recipient field 110 for a goods recipient that will receive the sold goods. When the user enters a value for the customer name, e.g. “Smith” 112, in the customer field 108, the value is sent to the back end 104, as illustrated by arrow 114, for a search to be performed for any goods recipient value(s) that can be automatically entered in the field 110.

The back end 104 has an application program 116 and a master data repository 124. In this example, the application program is configured for creating and maintaining sales orders. The master data includes preexisting data used by the application program 116 and other programs. The application program 116 has a component 118 that finds related entry value(s) and a component 120 that manages collections of hits. For example, the component 118 causes a query 122 relating to “Smith” to be performed in the master data repository 124. Here, the query seeks any goods recipient value that is associated with the customer “Smith”. In other implementations, the components 118 and 120 may be combined.

The application program 116 receives the results of querying the master data repository 124. For example, the results are that five possible goods recipients are identified for “Smith” as indicated by an arrow 126. The component 120 determines which value(s) to send to the front end. Particularly, the component 120 determines whether the number of values in the result exceeds a maximum number of values that the field 110 is configured to accept. Here, the field 110 is configured to accept no more than one value, so the number of values in the result exceeds this maximum value. The component 120 therefore selects one or more values from the identified values, up to the maximum number, and forwards the value(s) to the front end, as indicated by arrow 128. The selected value(s) is associated with the input field and will be included in the sales order upon creation, unless the user before then changes to another value for the input field. Moreover, the back end causes the front end to present a visual indicator to the user that the value(s) was selected from a larger set, as indicated by arrow 130. In some embodiments, the transmissions represented by arrows 128 and 130 can be combined in a single transmission.

When the back end 104 identifies a larger number of results than can be accepted in the input field, the results may be buffered as buffered information 129. This buffering may be done in an application layer of the back end—i.e., a layer of the back end where the application program 116 is being executed—and may eliminate the need to later run another search in the master data repository. In some implementations, the buffering includes the entire set of results and in other implementations the buffering includes the remainder of the results after the at least one value has been automatically selected, to name two examples.

Here, Springfield is selected as a default entry and forwarded to the front end. The back end 104 may use various ways of determining which value(s) from the search results to forward to the front end 102 when the results exceed the maximum for the input field. By contrast, when the results are less than or equal to the maximum number, the back end forwards all the results for automatic association with the input field.

One way that the back end chooses between the values in the search results, when the results exceed the maximum number, is to maintain a default flag in the master data. Such a default flag indicates, for example, which of the five goods recipients is to be the default when a user enters “Smith”. Thus, a priority setting in the back end can be used in selecting the value(s). Another way is for the back end to choose through the use of other data. For example, if multiple values have been identified for a sales group field, the back end may choose a sales group that is in the same state as the customer. As another example, the value(s) can be selected using data from the master data repository, such as customer information. Another way of choosing is to randomly select the value(s). For example, when the back end search feature almost always identifies the most relevant values, then the remaining choice between these alternatives can be performed randomly. In each example of automatic value selection, the system 100 allows the user to later choose another value or values.

Upon receiving at least one response from the back end 104, the front end 102 is updated to present GUI 107′, as schematically shown. Particularly, the front end 102 populates the goods recipient field 110 with the value “Springfield” and provides a visual indicator that more goods recipients than the one displayed were found. This informs the user that the value in the field 110, contrary to the value in the field 108, was entered by the system and that it was automatically selected from a larger set of values. In this example, Springfield represents a particular goods recipient located in a place called “Springfield”.

Implementations may use one of more types of visual indicators. The visual indicator may be presented in a message log 136 that may be visible in a portion of the GUI 107′. The message log 136 allows the system to publish alerts and other notices to the user regarding the current sales order or other system events. The system may be configured to provide the user access to the buffered information 129, which access may take place using the message posted to the message log. The buffered information 129 may be associated with the current sales order through an identifier 138. As another example, the visual indicator may be a highlighting of the field 110 or the word “Springfield” therein.

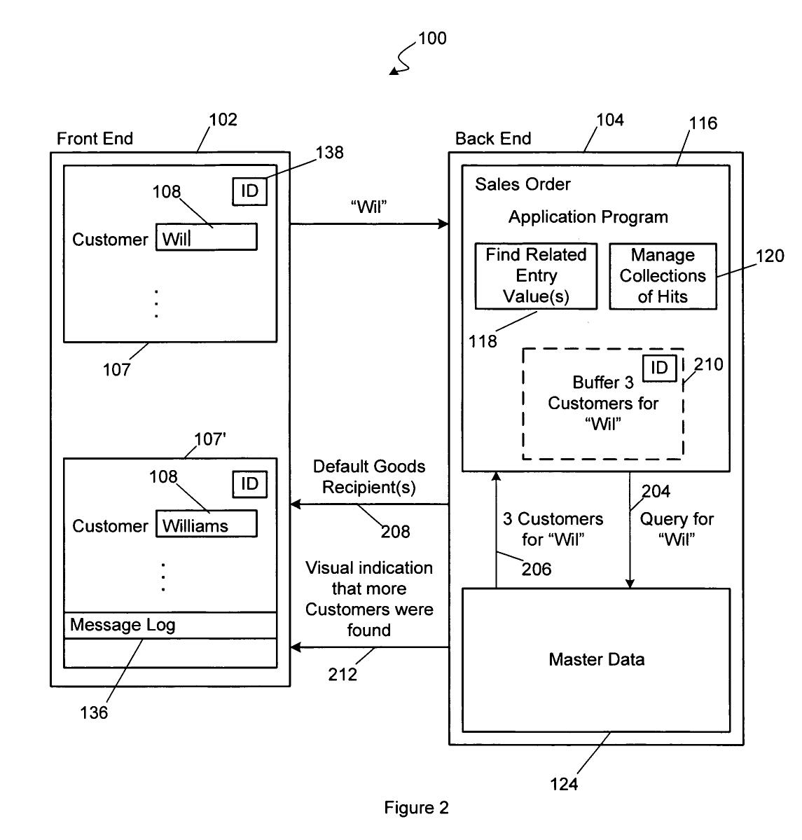

FIG. 2 illustrates an example of the system 100 being used to complete the field 108 after some initial text has been entered. That is, the data that the system automatically identifies, perhaps by selecting it from a larger set of search results, is here to be entered in the same field that the user is typing in. As such, this example may be considered an automatic completion feature, where upon the user typing one or more characters, the system responds with an entry. This feature may be configured to begin searching for matches once the user has entered a predefined number of characters in the input field. In this example, when the user enters the text “Wil” in the Customer field 108, the value is sent to the back end 104, as shown by arrow 202, for a search to be performed for any values that can be used to complete the field 108.

The component 118 causes a query relating to “Wil” to be performed in the master data repository 124. Here the query seeks any customer value that starts with the text “Wil”. In this example, the results are that three possible customers beginning with “Wil” are identified, as indicated by an arrow 206.

Here, the field 108 is configured to accept no more than one value, so the identified number of values exceeds this maximum. The component 120 therefore selects one of the values, “Williams”, and forwards it to the front end 102 as indicated by arrow 208. Here, the results are buffered as buffered information 210 which the user can later access, for example using a visual indicator, to select a different value for the field. Arrow 212 illustrates the backend triggering the front end to present a visual indicator to the user that the back end selected the value(s) was selected from a larger set that resulted from the query. In some embodiments, the transmissions represented by arrows 208 and 212 can be combined in a single transmission.

The front end 102 replaces the user-entered string in the customer field 108 with the value “Williams”. The front end also provides a visual indicator, such as in the message log 136, that more customers than the one displayed were found. If the user chooses, he or she can access the buffered information 210 and make an alternate selection. As another example, the visual indicator may be a highlighting of the customer field 108 or the word “Williams” therein.

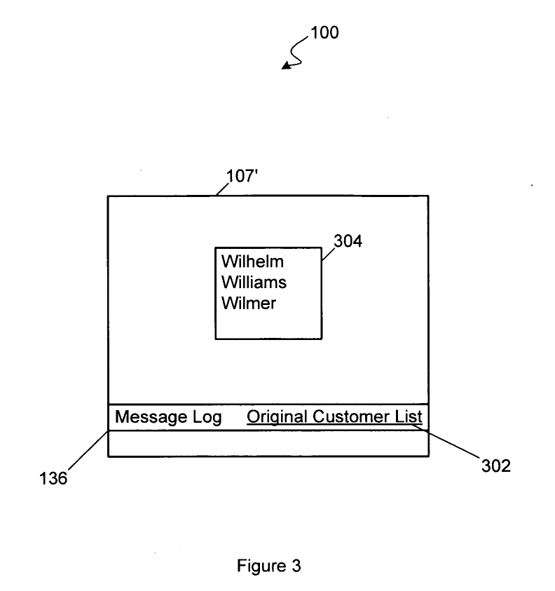

FIG. 3 illustrates one way, for instance, that the GUI 107′ visually indicates that one or more automatically entered values was selected from a larger set and lets the user select a value that is different than the one currently entered. In this case, the user entered “Wil” in the customer field 108 and the system selected “Williams” out of search results that included “Wilhelm”, “Williams” and “Wilmer”. The GUI 107′ displays a hyperlink 302 in the message log 136 that, when clicked on by the user, opens a new area 304 in the GUI, such as a popup window. The area 304 includes a list of values obtained from the buffered information 210. The area 304 presents all the values that were identified in the search, or optionally only the remainder of values after one or more of them has been automatically selected for the input field. The user may choose a new value from the list to replace the previous selection, or keep the current value, or enter in a value in the input field that is not included in the list.

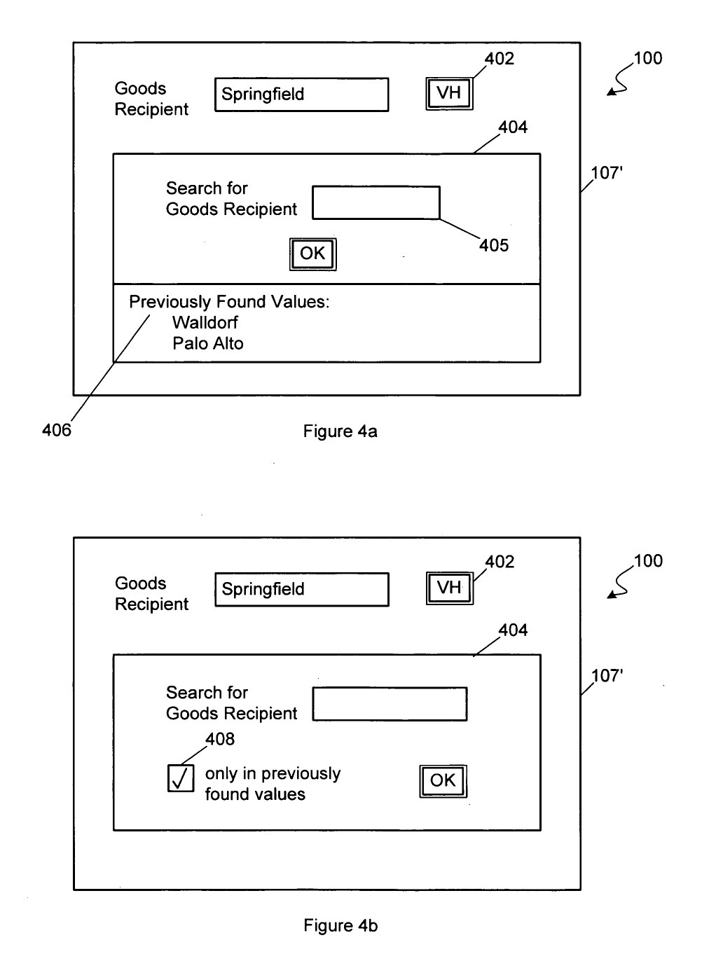

FIGS. 4a and 4b illustrate two examples of how the system 100 may incorporate value help to aid the user in making a value entry in the field or to change the value displayed in a field. In the example shown in FIG. 4a , the system populates the goods recipient field with the value “Springfield”, as described with reference to FIG. 1. In this example, a value help icon 402 appears next to the goods recipient field. The user can select the icon 402 to activate the value help function. When the user clicks on the value help icon, a popup window 404 is displayed in the GUI 107.

The popup window 404 allows the user to search for and review other possible input values for the field 106. The example of the popup window illustrated in FIG. 4a includes a search field 405 and a list 406 of previously found values. The user can enter text in the field 405 to perform a search for values that match the entered text and that are valid entries for the goods recipient field. In other implementations, the window 404 may include several search fields directed at different types of data, such as country, region and ZIP code, to name a few examples.

The list of previously found values 406 includes some or all of the buffered items. Here, each of the values “Walldorf” and “Palo Alto” represents a specific goods recipient located in the respective city. In other implementations, the values for goods recipient may include the name of the party receiving the goods. Thus, the list 406 visually indicates to the user that the value “Springfield” that is currently shown in the input field was selected from a larger set of search results. The user can select any of the values in the list 406 to replace the current value by clicking on the value(s).

The values mentioned in these examples, i.e. those displayed in the input fields or in the area 304 or the list 406, may represent larger collections of information. For example, the selected goods recipient Springfield may be associated with a physical address, alternative delivery modes and a contact person. Similarly, the selected customer Williams is associated with a customer number, an indicator for the type of business and one or more responsible employees. Also, the values selected by the back end need not be displayed in the front end. For example, the goods recipient field 110 may be a hidden field that is not visible to the user and that can be automatically filled as described. The visual indicator may then prompt the user to check the hidden value and, if necessary, select one or more new values for the hidden field.

FIG. 4b illustrates an example where the GUI 107′ allows the user to search within previous results or to perform a new search. A field 408 is checked by default and indicates that the search is performed only within the previously identified results, for example in buffer 129. Thus, the visual indicator may be that the search function of the value help is automatically modified. If, in contrast, the user wishes to perform a new search independently of the previous results, the user can un-check the field 408, enter a value in the search field and click the OK button. Any values that meet the search term(s) and that are valid entries for the goods recipient field will be presented by the value help function. This search may be performed in the entire master data repository 124.

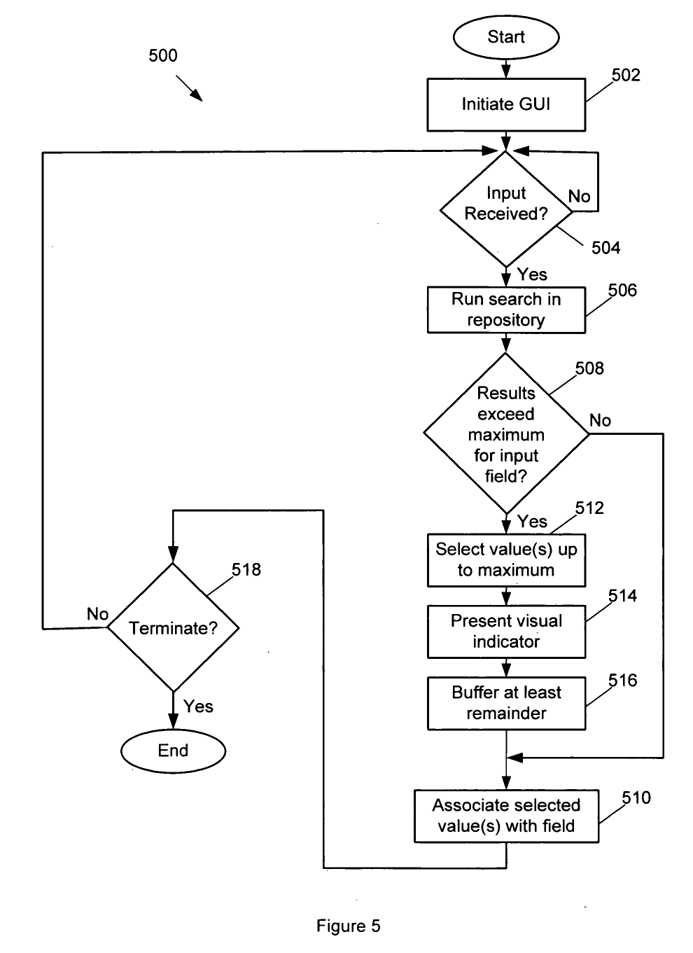

FIG. 5 is a flow chart of exemplary operations 500 that can be performed in the system 100, for example. The operations 500 can be performed by a processor executing instructions stored in a computer program product. The operations 500 begin, in step 502, with initiating a GUI. The GUI is configured for user entry of information for an electronic document that is to be created. For example, the system 100 can initiate the GUI 107 in the front end 102. In step 504, the operations query whether an input string has been received. The input is received upon a user entering a value into an input field of the GUI. If no input string has been received, the GUI repeats step 504.

If, in contrast, an input string has been received in step 504, the operations search a repository using the received input string in step 506. The repository is searched for any value that is to be automatically associated with an input field in the GUI for inclusion in the electronic document. The sought term(s) may be for a different field than the one where the input string was typed, as illustrated in FIG. 1, or for the same field, as illustrated in FIG. 2. For example, the component 118 in the back end 104 can search the master data repository 124. The search can be performed in other information associated with the identified party, for example to search one or more contracts of the identified customer to identify a goods recipient entered therein.

When the search results are received, the operations 500 determine, in step 508, whether the number of values exceeds a maximum number of values that the input field is configured to accept. For example, the component 120 can make this determination. If the number of values is less than or equal to the maximum number, or if there is no maximum number for the field, the operations 500 associate the identified value(s) with the field in step 510.

If, in contrast, the search identifies a number of values that exceeds a maximum number of values that the input field is configured to accept, steps 512-516 may also be performed. In step 512, the operations 500 selects value(s) from the identified values up to the maximum number of values. For example, if the input field accepts no more than one value, one value should be selected. The selection can be done based on a priority setting, using information retrieved from the GUI, using information retrieved from the master data repository, or by random drawing, to name a few examples.

In step 514, a visual indicator is presented to the user that the associated at least one value was selected from the identified values. In some implementations, the visual indicator is a highlighted input field or entry, or a message displayed to the user. As other examples, the visual indicator may be a list of previously found values presented in a value help function or an automatic modification of a search function in such a value help. Some or all of the results may be buffered in step 516. This allows the user to later inspect the set of results from which the system automatically selected the entered value(s). For example, the entire results or the remainder thereof may be buffered. The value(s) selected in step 512 are associated with the input field in step 510.

In a step 518 the operations 500 continues with again performing step 504 unless they are being terminated.

The sales order that has been described above is one example of an electronic document. The methods and techniques described herein can be used with many types of electronic documents, such as in creating service orders, in filling out online forms and in generating emails, to name a few examples.

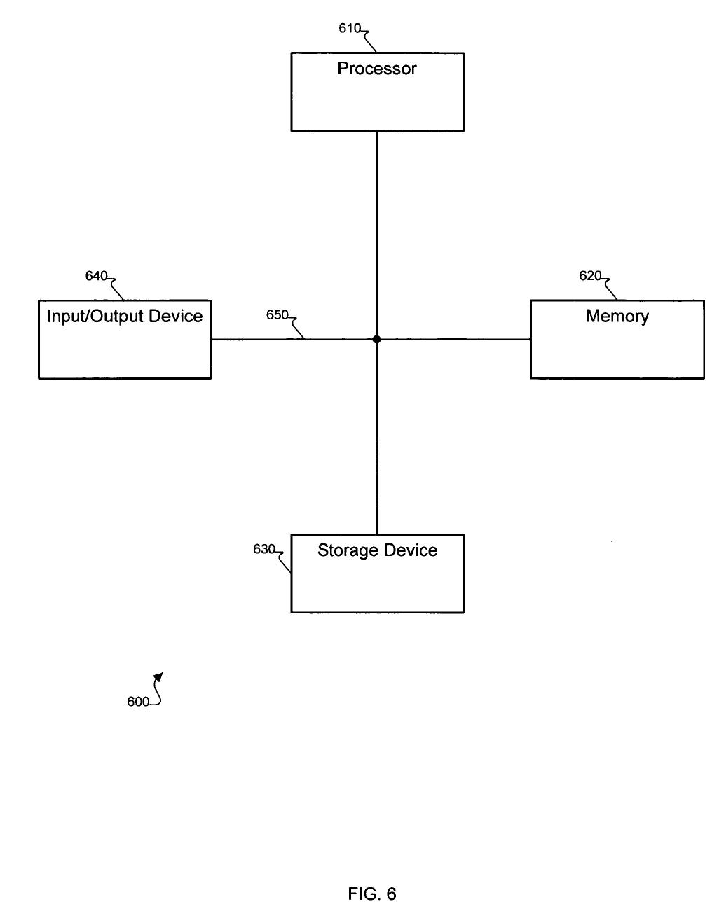

FIG. 6 is a block diagram of a computer system 600 that can be used in the operations described above, according to one embodiment. For example, the system 600 may be included in the system 100.

The system 600 includes a processor 610, a memory 620, a storage device 630, and an input/output device 640. Each of the components 610, 620, 630, and 640 are interconnected using a system bus 650. The processor 610 is capable of processing instructions for execution within the system 600. In one embodiment, the processor 610 is a single-threaded processor. In another embodiment, the processor 610 is a multi-threaded processor. The processor 610 is capable of processing instructions stored in the memory 620 or on the storage device 630 to display graphical information for a user interface on the input/output device 640.

The memory 620 stores information within the system 600. In one embodiment, the memory 620 is a computer-readable medium. In one embodiment, the memory 620 is a volatile memory unit. In another embodiment, the memory 620 is a non-volatile memory unit.

The storage device 630 is capable of providing mass storage for the system 600. In one embodiment, the storage device 630 is a computer-readable medium. In various different embodiments, the storage device 630 may be a floppy disk device, a hard disk device, an optical disk device, or a tape device.

The input/output device 640 provides input/output operations for the system 600. In one embodiment, the input/output device 640 includes a keyboard and/or pointing device. In one embodiment, the input/output device 640 includes a display unit for displaying graphical user interfaces.

The invention can be implemented in digital electronic circuitry, or in computer hardware, firmware, software, or in combinations of them. Apparatus of the invention can be implemented in a computer program product tangibly embodied in an information carrier, e.g., in a machine-readable storage device or in a propagated signal, for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the invention can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The invention can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. Accordingly, other embodiments are within the scope of the following claims.

What is claimed is:

1. A method to be performed upon a user entering information for creating an electronic document, the method comprising:
receiving in a computer system an input string that a user enters under guidance of a graphical user interface (GUI) that is configured for user entry of information for an electronic document that is to be created;
searching, using the received input string, a repository for any value that is to be automatically associated with an input field in the GUI for inclusion in the electronic document; and
upon the search identifying a number of values that exceeds a maximum number of values that the input field is configured to accept:
1) associating with the input field at least one value selected from the identified values up to the maximum number of values;
2) presenting a visual indicator to the user that the associated at least one value was selected from the identified values.

2. The method of claim 1, wherein the user enters the input string to make an entry for the input field and wherein associating the at least one value with the input field comprises replacing the input string with the at least one value.

3. The method of claim 1, wherein the user enters the input string to make an entry for another input field in the GUI than the input field.

4. The method of claim 1, wherein the at least one value is selected from the identified values based on a priority setting.

5. The method of claim 1, wherein the at least one value is selected from the identified values using data from another input field in the GUI.

6. The method of claim 1, wherein the at least one value is selected from the identified values using data from the repository.

7. The method of claim 1, wherein the at least one value is randomly selected from the identified values.

8. The method of claim 1, wherein the GUI further includes a message log that the user can access, and wherein presenting the visual indicator comprises adding a message to the message log.

9. The method of claim 1, wherein the visual indicator comprises a user-selectable input control that the user can activate to have the computer system present at least the remainder of the identified values.

10. The method of claim 1, wherein the computer system includes a help function that the user can activate in relation to the input field to have the system present at least one candidate value that the input field is configured to accept.

11. The method of claim 10, wherein presenting the visual indicator comprises presenting at least a remainder of the identified values in the GUI upon the user activating the help function.

12. The method of claim 10, wherein the help function provides that the user can also search for candidate values that are not included in the identified values.

13. The method of claim 10, wherein presenting the visual indicator comprises automatically modifying a search function that is included in the help function.

14. The method of claim 1, wherein the at least one value is not displayed in the GUI upon being associated with the input field.

15. The method of claim 1, wherein the at least one value is displayed in the GUI upon being associated with the input field, and wherein presenting the visual indicator comprises highlighting the at least one value in the GUI.

16. The method of claim 1, further comprising storing at least a remainder of the identified values for user viewing.

17. The method of claim 16, wherein the storing comprises buffering at least the remainder of the identified values in an application layer of the computer system.

18. A computer program product tangibly embodied in an information carrier, the computer program product including instructions that, when executed, cause a processor to perform operations comprising:
receiving in a computer system an input string that a user enters under guidance of a graphical user interface (GUI) that is configured for user entry of information for an electronic document that is to be created;
searching, using the received input string, a repository for any value that is to be automatically associated with an input field in the GUI for inclusion in the electronic document; and
upon the search identifying a number of values that exceeds a maximum number of values that the input field is configured to accept:
1) associating with the input field at least one value selected from the identified values up to the maximum number of values;
2) presenting a visual indicator to the user that the associated at least one value was selected from the identified values.

19. A method to be performed upon a user entering information for creating an electronic document, the method comprising:
receiving in a computer system an input string that a user enters under guidance of an input field in a graphical user interface (GUI) that is configured for user entry of information for an electronic document that is to be created;
searching, using the received input string, a repository for any value that is to be automatically associated with another input field in the GUI for inclusion in the electronic document; and
upon the search identifying a number of values that exceeds a maximum number of values that the input field is configured to accept:
1) associating with the other input field at least one value selected from the identified values up to the maximum number of values;
2) buffering information including at least a remainder of the identified values;
3) presenting a visual indicator to the user that the associated at least one value was selected from the identified values, wherein the user can access the buffered information using the visual indicator.

20. The method of claim 19, wherein the at least one value and the remainder of the identified values are buffered.

21. The method of claim 19, wherein the computer system includes a help function that the user can activate in relation to the other input field to have the system present at least one candidate value that the other input field is configured to accept, and wherein the visual indicator is presented in association with the help function.

22. The method of claim 21, wherein the help function provides that the user can also search for candidate values that are not included in the buffered information.
